(19) United States
(12) Patent Application Publication
(10) Pub. No.: US 2005/0209539 A1
(43) Pub. Date: Sep. 22, 2005

(54) Body therapy apparatus

(76) Inventors: Mordechai Lev, West Bloomfield, MI (US); Roman S. Ferber, West Bloomfield, MI (US); Stephen Chung, Taipei (TW)

Correspondence Address: BROOKS KUSHMAN P.C., 1000 TOWN CENTER, TWENTY-SECOND FLOOR, SOUTHFIELD, MI, 48075, US

(21) Appl. No.: 11/082,074

(22) Filed: Mar. 16, 2005

Related U.S. Application Data
(60) Provisional application No. 60/554,892, filed on Mar. 19, 2004.

(51) Int. Cl. A61H 1/00

(52) U.S. Cl. 601/22; 601/55; 601/88; 601/148

(57) ABSTRACT

A foot therapy apparatus is provided having a bladder for retaining fluid. The bladder is sized and supported for receiving a user's feet thereon. The foot therapy apparatus may include various therapeutic features, such as a fluid pump for providing a fluid flow massage effect to the feet of the user. A heater may be provided for heating the fluid. The bladder may be translucent and LED's may be provided in a substrate that supports the bladder for conveying an illumination effect through the bladder.

### CROSS-REFERENCE TO RELATED APPLICATIONS

This application claims the benefit of U.S. provisional application Ser. No. 60/554,892 filed Mar. 19, 2004.

### BACKGROUND OF THE INVENTION

1. Field of the Invention

The invention relates to a body therapy apparatus, particularly to a foot therapy apparatus.

2. Background Art

Most people experience foot problems at some time in their lives. This is not surprising, considering that many people are employed in jobs that require them to be on their feet all day. In fact, even an average day of walking can exert force equal to several hundred tons of pressure on the feet.

In an attempt to alleviate a variety of podiatric problems, bathing of the feet has become a recognized therapeutic method. For example, soaking soothes the feet and aids recovery from fatigue. Bathing of the feet also stimulates the circulation of blood therethrough, which results in increased metabolism and excretion. In addition, foot bathing facilitates the removal of painful growths such as calluses, bunions, and corns.

Many types of foot baths have been utilized as therapeutic devices for the feet. Typically, foot baths provide heated water for which the temperature is maintained via electrical means. In addition, current foot baths often provide massage to the feet through vibration of the foot bath. Vibratory massage enhances the therapeutic results achieved with soaking alone by further increasing circulation as well as relaxing and massaging the muscles.

The prior art has provided air mattresses and water beds, which both utilize a fluid-tight mattress filled with air or water respectively for supporting the body of a user for rest and relaxation thereupon.

A need exists for a body therapy apparatus that is adapted to accommodate and provide various therapeutic features to a selected portion of the user's body.

### SUMMARY OF THE INVENTION

An aspect of the present invention is to provide a foot massager having a substrate and a flexible bladder mounted thereto. The bladder has a top surface spaced apart from an underlying support surface upon which the substrate rests. The top surface receives a pair of feet of a user. The bladder retains fluid for providing a flexible fluid support to the feet of the user. A fluid pump is in fluid communication with an aperture formed in the substrate for pumping the fluid within the bladder and imparting a fluid flow massage effect to the user's feet.

Another aspect of the present invention is to provide a foot therapy apparatus having a portable substrate adapted to rest upon an underlying support surface. A flexible bladder is mounted upon the substrate and retains fluid therein. A heater is mounted to the substrate for heating the fluid within the bladder for imparting a therapeutic heated fluid effect to the user's feet.

A further aspect of the present invention is to provide a foot therapy apparatus having a housing adapted to rest upon an underlying support surface. The housing has an internal cavity and an opening formed therein that is spaced apart and facing away from the underlying support surface. A substrate is mounted within the housing internal cavity adjacent to the opening. The bladder retains fluid for providing a flexible fluid support to a user's feet.

An additional aspect of the present invention is to provide a foot therapy apparatus having a flexible bladder for retaining fluid, the bladder being formed from a generally translucent material and being mounted to a substrate. A plurality of light emitting diodes are mounted to the substrate for conveying an illumination effect through the bladder.

### BRIEF DESCRIPTION OF THE DRAWINGS

FIG. 1 is an exemplary embodiment of a body therapy apparatus in accordance with the present invention;

FIG. 2 is a top plan view of the body therapy apparatus of FIG. 1;

FIG. 3 is an exploded side perspective view of the body therapy apparatus of FIG. 1;

FIG. 4 is a bottom plan view of the body therapy apparatus of FIG. 1, illustrated with a lower housing portion removed;

FIG. 5 is an enlarged partial section view illustrating the cooperation of a heater with a bladder of the body therapy massager of FIG. 1;

FIG. 6 is a top plan view of the body therapy apparatus of FIG. 1, illustrated disassembled from a housing thereof;

FIG. 7 is a partial, exemplary circuit diagram that may be employed by the body therapy apparatus of FIG. 1;

FIG. 8 is an enlarged fragmentary right side elevation view of the body therapy apparatus of FIG. 1, illustrated with a leg thereof in an extended position;

FIG. 9 is a top plan view of an alternative embodiment body therapy apparatus in accordance with the present invention; and

FIG. 10 is a top plan view of another alternative embodiment body therapy apparatus in accordance with the present invention.

### DETAILED DESCRIPTION OF EMBODIMENTS OF THE INVENTION

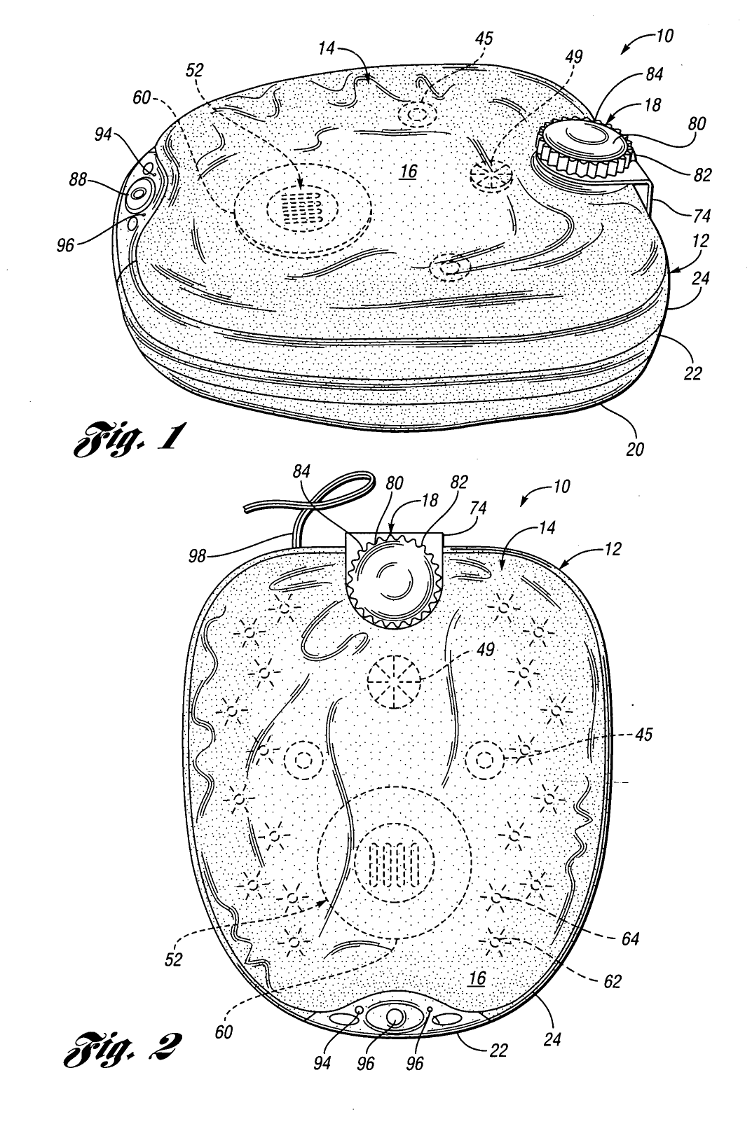

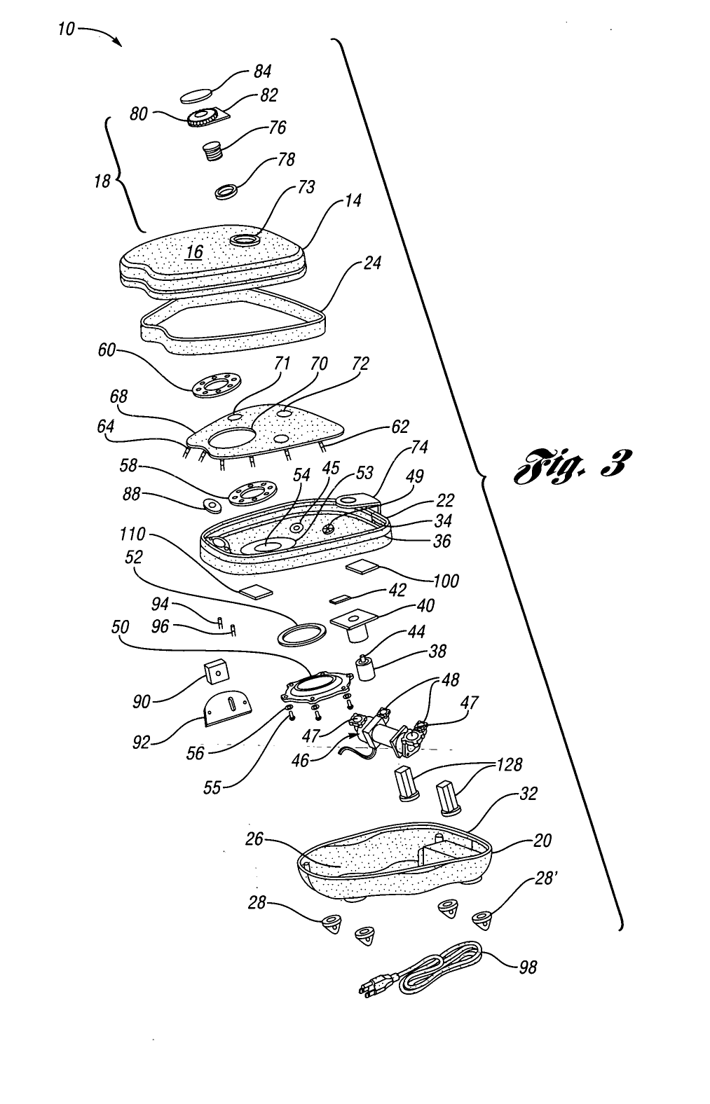

With reference now to FIGS. 1 and 2, an exemplary embodiment body therapy apparatus is illustrated, particularly referred to as a foot therapy apparatus and referenced generally by numeral 10. The foot therapy apparatus 10 is preferably constructed from a plastic material so as to be lightweight and portable, as well as durable, leak proof, and corrosion resistant. Although the foot therapy apparatus 10 is illustrated and described herein as being particularly adaptable for foot therapy it is understood that the foot therapy apparatus 10 of the present invention may be used for therapy of other body parts, such as hands, head or the like.

The foot therapy apparatus 10 generally comprises a housing 12 with a flexible bladder 14 affixed thereto. The housing 12 provides ease in portability of the foot therapy apparatus 10 and is adapted to rest upon an underlying support surface. Particularly, the foot therapy apparatus 10 may be rested upon a floor for use by a user while sitting in a chair adjacent to the foot therapy apparatus 10. The flexible bladder 14 provides a foot rest surface 16 thereon, which is spaced apart from the underlying support surface and is sized to receive a pair of feet of the user thereupon. The bladder 14 has an internal cavity (not shown) for retaining fluid therein, particularly water. The foot therapy apparatus 10 provides a flexible fluid support to the feet of the user as the feet are rested thereon, thereby providing comfort and relaxation to the feet of the user. Unlike prior art foot therapy apparatuses, which require the user to place its feet upon a rigid surface, or cushioned surface, the foot rest surface 16 of the present invention provides support which contours to the shape of the user's foot, thereby distributing the resultant load experienced by the user's feet evenly across the surface area which engages the bladder 14.

Of course, the invention contemplates that the above-described benefits and comforts may be experienced by various parts of the user's body other than the feet.

The bladder 14 may be formed of any flexible fluid type material. One having ordinary skill in the art would recognize that various elastomeric materials would satisfy the fluid type requirement and would be cost effective for providing this solution. Examples of such materials include low density polyethylene (LDPE) or terephthalate (TEPE).

The bladder 14 includes a spout 18 for permitting the user to fill and drain the bladder 14 as desired. Therefore, a manufacturer of the foot therapy apparatus 10 may package the foot therapy apparatus 10 with a drained bladder 14 and the user may fill the bladder 14 prior to use thereby minimizing the weight of the packaged product. The spout 18 also allows the user to drain and replenish the bladder 14 as desired to suit the user's preference.

The foot therapy apparatus 10 provides other therapeutic features, such as massage, heat and aesthetic illumination. The massage feature may impart a vibratory massage effect to the housing 12 thereby imparting the vibratory massage effect to the fluid retained within the bladder 14. The vibratory massage effect is subsequently imparted to the feet of the user that are rested upon the foot rest surface 16. Accordingly, a fluid vibratory massage effect is imparted to the feet of the user that is comforting and relaxing and less rigid than a conventional vibratory massage effect that is imparted directly through a mechanical operation to the user.

The massage feature may also pump the fluid within the bladder 14 to create a fluid flow massage effect to the feet of the user.

The heat function imparts heat to the fluid within the bladder 14 thereby providing a heated soothing, therapeutic effect to the surface of the user's feet.

Referring now to FIGS. 1 through 6, the foot therapy apparatus 10 is described in greater detail. Referring specifically to FIG. 3, the housing 12 comprises a lower housing portion 20, an upper housing portion 22, and a side wall 24. The lower housing portion 20 is generally tub shaped with an inner cavity 26 provided therein for housing several of the operational components of the foot therapy apparatus 10. The lower housing portion 20 is adapted to rest upon the underlying support surface. Specifically, the lower housing portion 20 includes a plurality of feet 28 with a pair of rearmost feet 28′. The feet 28 support the foot therapy apparatus 10 upon the underlying support surface and have characteristics that are generally compliant and dampening for minimizing the vibrations imparted from the foot therapy apparatus 10 to the underlying support surface.

The upper housing portion 22 includes an outer peripheral region 30, which is adapted to mate with an upper peripheral edge 32 of the lower housing portion 20. The peripheral region 30 of the upper housing portion 22 includes a recess formed therein for receiving the upper peripheral edge 32 of the lower housing portion 20. Upon engagement of the upper and lower housing portions 22, 20 these portions are adhered together by fasteners, adhesive or the like. The upper housing portion 22 includes a substrate 34 provided therein for generally enclosing the inner cavity 26 of the lower housing portion 20 and for providing support to the fluid bladder 14.

The upper housing portion 22 includes a ridge 36 formed thereabout, which is sized to receive the side wall 24. The side wall 24 is open in its center and mates with the ridge 36 of the upper housing portion 22, extending upward therefrom. The side wall 24 is affixed to the upper housing portion 22 and at least partially surrounds lateral sides of the bladder 14 to provide generally uniform lateral support thereto for distributing lateral loads applied to the bladder 14 caused by hoop stress of the weight of the fluid retained therein, or caused by hoop stress provided from downward loading of the user's feet upon the foot rest surface 16, which causes displacement of the fluid both downwardly and outwardly. The side wall 24 could, for example, extend upward to substantially surround the bladder 14 laterally within the spirit and scope of the present invention.

The vibratory massage effect is generated by a motor 38 that is secured within the housing 12 by a motor mount 40. The motor mount 40 is fastened to the underside of the upper housing portion 22. An eccentric weight 42 is driven by an output shaft 44 of the motor 38. As power is selectively provided to the motor 38, the motor output shaft 44 is rotatably driven and the eccentric weight 42 thereby imparts a vibratory massage effect to the motor mount 40. The motor mount 40 is secured to the upper housing portion 22, and therefore the vibratory massage effect is translated thereto, and to the bladder 14 and its fluid contents. The bladder 14 and its retained fluid consequently undergo a vibratory massage effect, which is consequently imparted to the feet of the user.

The substrate 34 includes a pair of apertures 45 which act as water jets when water from the bladder 14 is pumped through them. The apertures 45 are oriented to force the water in an upward direction within the bladder 14 so that the forced water is applied to an internal side of the foot rest surface 16. The apertures 45 are spaced apart laterally to each generally align with the placement of the user's feet. Thus, each foot receives a fluid flow massage effect.

Water is forced through the apertures 45 by a fluid pump 46, which is illustrated in FIG. 3. The fluid pump 46 includes a pair of inlets 47 and a pair of outlets 48. The inlets 47 are configured to draw fluid through an intake port 49 in the substrate 34. The intake port 49 includes an upward projecting grated cover for preventing the bladder 14 from being pulled into the port 49. The inlets 47 may be in fluid communication with the intake port 49 through fluid fittings and tubing (not shown). Likewise, fittings and tubing may be provided to connect the outlets 48 to the apertures 45. In operation, the fluid pump 46 receives water from the bladder through the inlets 47 and pumps the water through the outlets 48. From the outlets 48, the water is forced into the bladder 14 through the apertures 45. The apertures 45 each include watertight seals to ensure that water does not seep into the housing 12.

The invention also contemplates use of any massage mechanism that may impart a massage effect or a vibratory massage effect upon the bladder 14.

The heat effect provided to the bladder 14 is provided by a heater 50 as illustrated specifically in FIGS. 3 through 5. The vibratory and fluid flow massage effects improve the heat transfer of heat to the fluid within the bladder 14 and facilitate generally uniform distribution of the heat by vibrating and pumping the fluid and imparting motion thereto thereby “stirring” the fluid as it is heated. The heater 50 is illustrated as a sheath heater, which transfers heat across a surface area. Sheath heaters are commonly utilized in the art of coffee urns. In order to enhance the thermal conductivity between the heater 50 and the fluid contents of the bladder 14, an opening 51 is provided in the underside of the bladder 14.

In order to maintain a water-tight connection between the bladder 14, substrate 34 and heater 50, a plurality of seals are provided therebetween. Specifically, a silicon disk 52 is secured between the heater 50 and the substrate 34. The substrate 34 includes a flange 53 centrally disposed thereon with a central aperture 54 formed therethrough and hole pattern corresponding with a hole pattern formed about the heater 50. A plurality of screws 55 are provided with nylon washers 56 for securing the heater 50 to the substrate flange 53 with the silicon disk 52 provided therebetween. The nylon washers 56 prevent heat from being imparted directly to the screws 55, thereby minimizing repetitious thermal expansion, which may cause loosening.

A lower nitrile rubber (NBR) seal 58 is provided atop the substrate flange 53. The lower seal 58 has a corresponding aperture formed therethrough and a mating hole pattern for receiving the screws 55 therethrough. An upper NBR seal 60 is also provided with an aperture formed therethrough and a corresponding hole pattern with threaded holes for receiving the screws 55. The upper seal 60 is disposed within the bladder 14 for clamping the bladder opening 51 between the upper seal 60 and the lower seal 58. Accordingly, the screws 55 collectively clamp the nylon washers 56, the heater 50, the silicon disk 52, the substrate flange 53, the lower seal 58, the underside of the bladder 14 and the upper seal 60 together thereby providing a water-tight seal therethrough and permitting heat to be conducted from the heater 50 through the silicon disk 52 directly to the fluid contents of the bladder 14.

Of course, the bladder 14 can be provided without an opening in the underside and heat from the heater 50 may be transferred through the underside wall of the bladder 14. However, this alternative arrangement would inhibit the transfer of heat from the heater 50 to the fluid within the bladder 14 and would thereby increase the time required to heat the bladder contents. Alternatively, the bladder 14 may be provided without an underside and the entire lower perimeter of the bladder 14 may be bonded directly to the substrate 34.

In the art of therapy and massage it is desirable to provide pleasing effects other than those that may be felt by the user. Accordingly, vibrational noise is dampened between the lower housing portion 20 and the underlying support surface due to the characteristics of the rubber feet 28 which absorb a vibrational impact therebetween, thus reducing the noise and vibrational harshness (NVH) provided by the massage effect.

Additionally, an aesthetically pleasing visual ambiance is provided through a display of light emitting diodes (LED). The exemplary embodiment foot therapy apparatus 10 includes a plurality of blue LED's 62 and red LED's 64 oriented between the bladder 14 and the substrate 34. The LED's 62, 64 are disposed within recesses 66 formed within the substrate 34. The LED's 62, 64 are maintained in orientation by an illumination plate 68. The illumination plate 68 is sized to rest upon the substrate 34 and transmit the load from the bladder 14 to the substrate 34. The illumination plate 68 also includes apertures 70, 71, 72 formed therethrough for providing clearance for the flange 53, jet apertures 45 and the intake port 49 respectively. The invention contemplates that the bladder 14 may be open on its underside and bonded directly to the illumination plate 68.

The LED's 62, 64 are arranged outward laterally towards the left hand and right hand sides of the foot therapy apparatus 10, as best illustrated in FIG. 2. The LEDs 62, 64 are arranged in alternating fashion to evenly distribute the blue LED's 62 and the red LED's 64 amongst the arrangement. The blue LED's 62 are illuminated when the massage function is operating. The red LED's 64 are illuminated when the heat function is operating. In order to facilitate this illumination, the illumination plate 68 and the bladder 14 are both generally translucent. Additionally, the side wall 24 is also generally translucent so that the illumination effects may be appreciated from indirect view perspectives relative to the top plan view.

Referring again to FIG. 3, the spout 18 is illustrated exploded in further detail. The bladder 14 includes a port 73 for providing access to its internal cavity. A spout bracket 74 is affixed to the upper housing portion 22 and extends over and aligned with the port 73. A plug 76 is provided with an NBR ring 78 received thereabout. The plug 76 cooperates with the port 73 for closing and sealing the port 73 by inserting the plug 76 into the port 73 and turning the plug 76 until the plug 76 is locked with the port 73 with a water tight seal provided therebetween by the NBR ring 78. The plug 76 is rotationally driven by a cap 80 which is secured thereto and includes external gripping configurations to enhance manual rotation. The cap 80 is pivotally secured to a hinge 82 that is affixed to the spout bracket 74 for retaining the plug 76 relative to the housing 12 at all times and preventing loss or misplacement of the plug 76. A translucent plate 84 is also provided for imbuing a decal or entrapping a manufacturer's logo, brand name or decoration between the plate 84 and the cap 80.

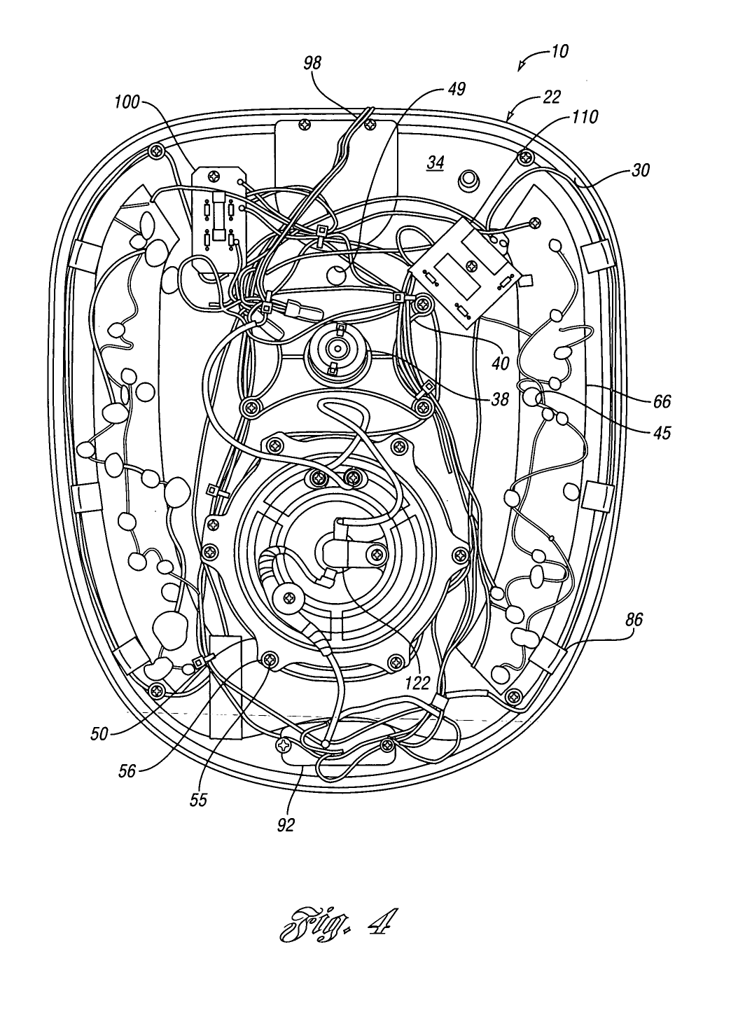

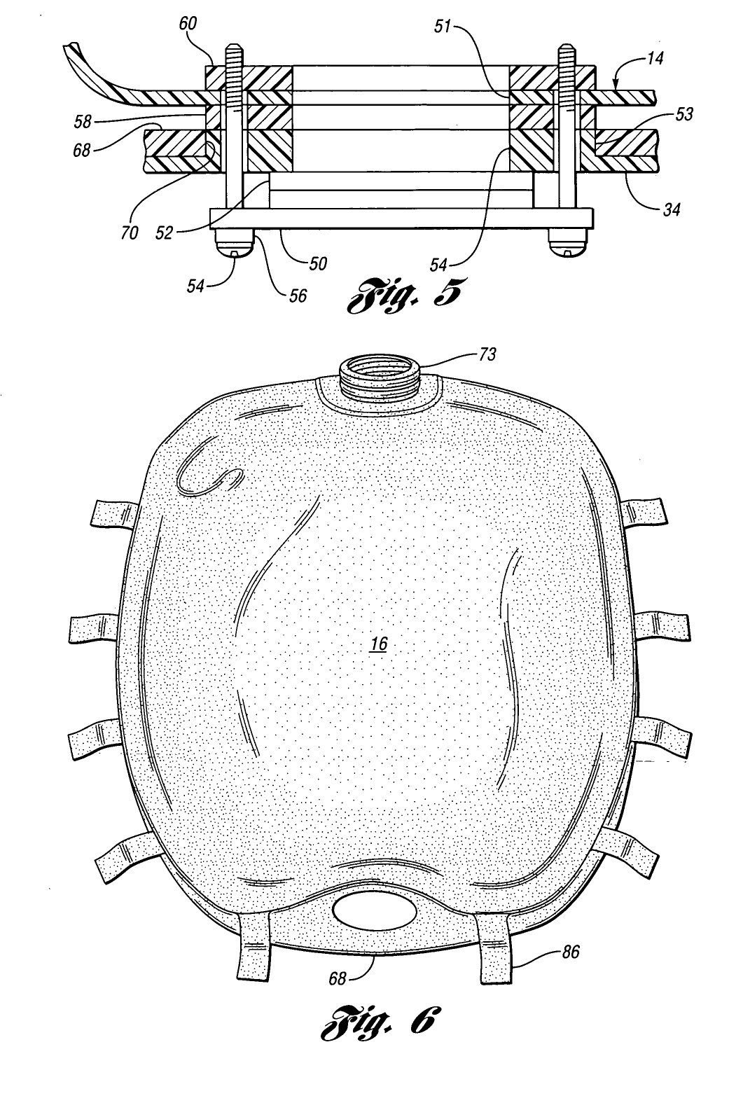

With reference again to FIG. 6, the bladder 14 is illustrated without being obfuscated by the housing 12. Specifically, the bladder 14 is provided with a series of tabs 86 extending generally outboard therefrom. The tabs 86 are both flexible and resilient and are utilized for anchoring the bladder 14 to the substrate 34. Referring now to FIG. 4, the anchors 86 extend through slots provided through the substrate 34. The tabs 86 are not provided around the entire perimeter of the bladder 14 because the spout bracket 74 provides adequate support to the port 73 thereby anchoring the rearward most region of the bladder 14 to the housing 12.

Referring again to FIGS. 1 through 4, the controls of the foot therapy apparatus 10 are illustrated. A depress button 88 is provided on a forward region of the upper housing portion 22. The depress button 88 is provided in this region for easy access to the user and is sufficiently sturdy to be depressed by a toe of the user.

The depress button 88 cooperates with a three position control switch 90 for selecting one of a plurality of operational modes of the foot therapy apparatus 10. The control switch 90 is secured underneath the upper housing portion 22 and cooperates with a printed circuit board (PCB) 92 adjacent thereto.

In operation, upon receiving a manual depression of the depress button 88, the control switch 90 is actuated to a first orientation corresponding with the massage mode. In the massage mode, the motor 38 and pump 46 are powered and impart the vibratory and fluid flow massage effects to the fluid within the bladder 14. Concurrently, the blue LED's 62 become illuminated. Further, an additional blue LED 94 is provided on the forward region of the upper housing portion 22 to indicate that the foot therapy apparatus 10 is in the massage mode.

Upon another depression of the depress button 88, the control switch 90 is actuated to a second position wherein the foot therapy apparatus 10 operates in both the massage mode and the heat mode. In the combined massage and heat modes, the above listed functions of the massage mode are in operation. Additionally, power is imparted to the heater 50 thereby generating heat which is transferred to the fluid within the bladder 14. Additionally, the series of red LED's 64 become illuminated to indicate that the heater is in operation and to provide an aesthetic illuminated appearance that is commonly associated with heat. Further, another red LED 96 is provided on the forward region of the upper housing portion 22 to confirm that the foot therapy apparatus 10 is in the heat mode. Once the depress button 88 has been pushed a third time by the user, the control switch 90 is actuated to the third or original position wherein the circuits are open for both the massage and heat modes thereby terminating operation of both modes.

The invention contemplates various alternative operations of the massage and heat modes. For example, the series of LED's 62 and 64 may perform a function that is primarily aesthetic in nature as the indicator LED's 94 and 96 provide visual affirmation of the selected mode of the foot therapy apparatus 10. The series of LED's 62, 64 do not need be relied upon for indicating the mode only. For example, when the heat mode is turned on, the red LED 96 may indicate that the foot therapy apparatus 10 is in the heat mode, however the illumination of the red LED's 64 may be delayed until the fluid within the bladder 14 reaches a desired heat therapy temperature. Additionally, the control switch 90 may be replaced with a four position control switch for actuation of a heat only mode, wherein the massage mode is turned off and only heat therapy is provided to the user. Further, the control switch 90 may be replaced with a five position control switch for actuation of a vibration massage mode, a fluid flow massage mode, a vibration and fluid flow massage mode, and a massage and heat mode. Of course, the invention contemplates various combinations of operations of the massage and heat functions and a control switch for providing the desired combinations.

Alternatively, the circuitry of the foot therapy apparatus 10 may include an integrated circuit chip for providing an aesthetically pleasing LED display, which may be a coordinated arrangement of illumination and timing of the various LEDs or may be random in nature. Such a feature would provide visual relaxation, comfort and enjoyment to the user concomitantly with the physical therapeutic features of the foot therapy apparatus 10.

Referring again to FIG. 3, the foot therapy apparatus 10 includes a power cord 98 for receiving power from an AC power source. Of course, the invention contemplates operation provided by a DC power source as well. Power is subsequently converted to DC via a transformer at PCB 100.

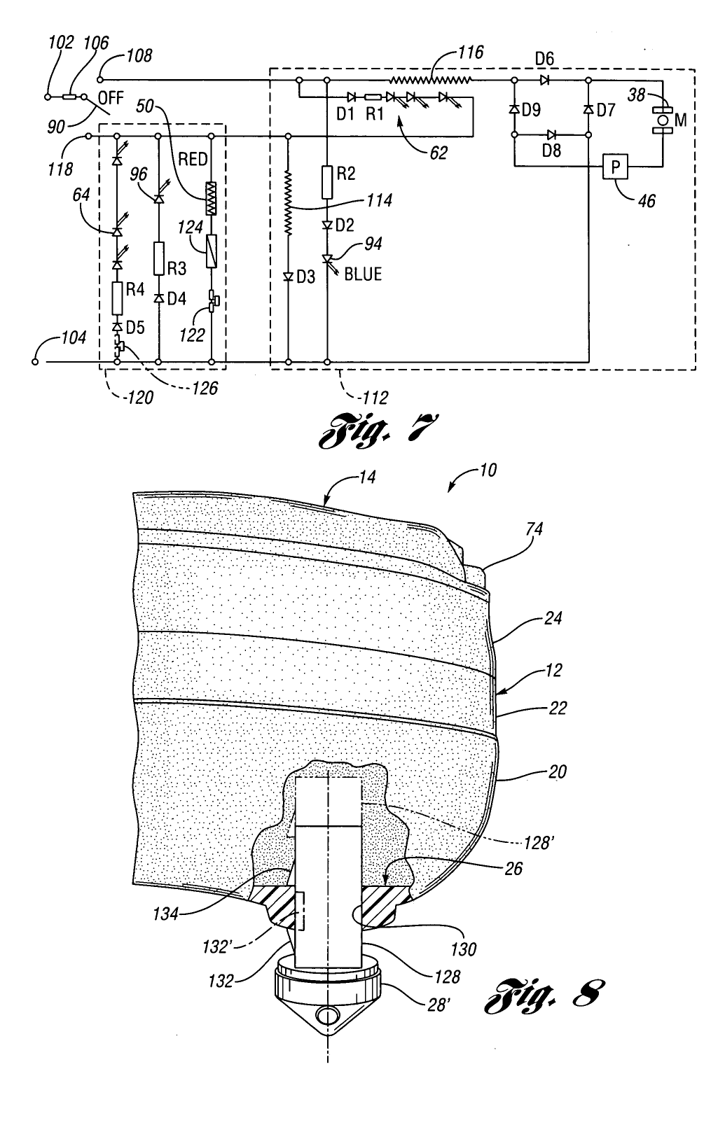

Referring now to FIG. 7, a circuit diagram is presented illustrating, by example, the control of the foot therapy apparatus 10. The DC power supply is connected to node 102 and a ground is connected to node 104. The DC power 102 is passed through a fuse 106 to the control switch 90. Diodes, which limit direction are illustrated in the diagram and labeled D1 through D9 and are provided in the circuitry within the housing 12 and may be affixed to the various PCBs such as the control switch PCB 92, the transformer PCB 100 or an additional PCB 110. Further, various resistors are provided in the diagram and are labeled R1 through R4 and are also provided in the circuitry within the housing 12.

In position one of the control switch 90, illustrated at node 108, the massage mode is turned on. The circuitry associated with the massage mode is illustrated in massage block 112. The DC current in the massage block is directed through the series of blue LED's 62 and through a voltage drop 114 to ground 104. Additional current is passed through the blue indicator LED 94 to the ground 104. Further, current is passed through a voltage drop 116, diode D6, motor 38, pump 46 and diode D8 to ground 104, powering the motor 38 and pump 46 for generating the massage effects.

When the switch 90 is actuated to the second position as illustrated by node 118, both the massage mode and heat mode are operated as the current is passed through massage block 112 and a heat block 120. As current is passed through the heat block 120, the current powers the heater 50, which is protected by a normally-closed thermostat 122. The thermostat 122 opens the circuit and discontinues current through the heater 50 upon reaching a predetermined desired temperature for the heat therapy. Additionally, a fuse 124 or thermal cut-off is provided to open the circuit upon obtaining a temperature that is greater than that permitted by the normally-open thermostat 122.

In the heat mode, as current is passed through heat block 120, the red LED's 64 are illuminated as well as the red indicator LED 96. Once the control switch 90 is actuated to the third or off position, both circuits are open terminating current to the massage block 112 and the heat block 120, thereby discontinuing electrically powered therapy operation of the foot therapy apparatus 10.

As discussed above, a fourth position could be provided to the control switch 90 which passes current to the heat block 120 only and not the massage block 112. If it is desired to delay illumination of the red LED's 64 until the heater 50 has obtained a predetermined heat therapy temperature, a normally-open thermostat 126 is illustrated in phantom which prevents current from passing through the series of red LED's 64 until the heater 50 obtains a predefined temperature that is less than the maximum permitted by the normally closed thermostat 122.

As discussed above, the pump 46 could be separated from the motor 38 for providing various massage effects.

With reference now to FIG. 8, an adjustment feature is illustrated for the pair of rear feet 28′. The rear feet 28′ may each be provided with a foot extension 128 for allowing the user to adjust the height of the rearmost region of the foot therapy apparatus 10, to tilt the bladder 14 towards the user if desired. Specifically, the foot extension 128 extends through a slot 130 in the housing lower portion 20. Each foot extension 128 includes a lower leaf spring 132. The lower leaf spring 132 may be formed from a rigid polymeric material and may be formed integrally with the foot extension 128. In the extended position of the rear foot 28′, the lower leaf spring 132 is extended from the foot extension 128. The lower leaf spring 132 acts as a translational stop preventing the foot extension 128 from retracting back into the housing. In order to retract the rear foot 28′ towards the housing 12, the lower leaf spring 132 is depressed by the user and the rear foot 28′ and the foot extension 128 are urged toward the lower housing portion 20 thereby retracting the foot extension 128′ as illustrated in phantom. Upon urging the lower leaf spring 132 inward, it is received within a recess formed in the foot extension 128 and is illustrated in phantom and referenced by numeral 132′ in a recessed orientation of the leaf spring when the foot extension 128 is retracted.

When the user desires to extend the rear feet 28′, the user urges each rear foot 28′ away from the lower housing portion 22. As the foot extension 128 is being translated, it is prevented from being overextended by an upper leaf spring 134, which engages the internal cavity 26 of the lower housing portion 20. Upon full translation of the foot extension, the lower leaf spring 132 extends thereby locking the rear leg 28′ and the leg extension 128 in the extended position for providing the tilt to the foot therapy apparatus 10. The upper leaf spring 134 retracts within a recess in the foot extension 128 upon engagement with the slot 130 during assembly of the foot extension 128.

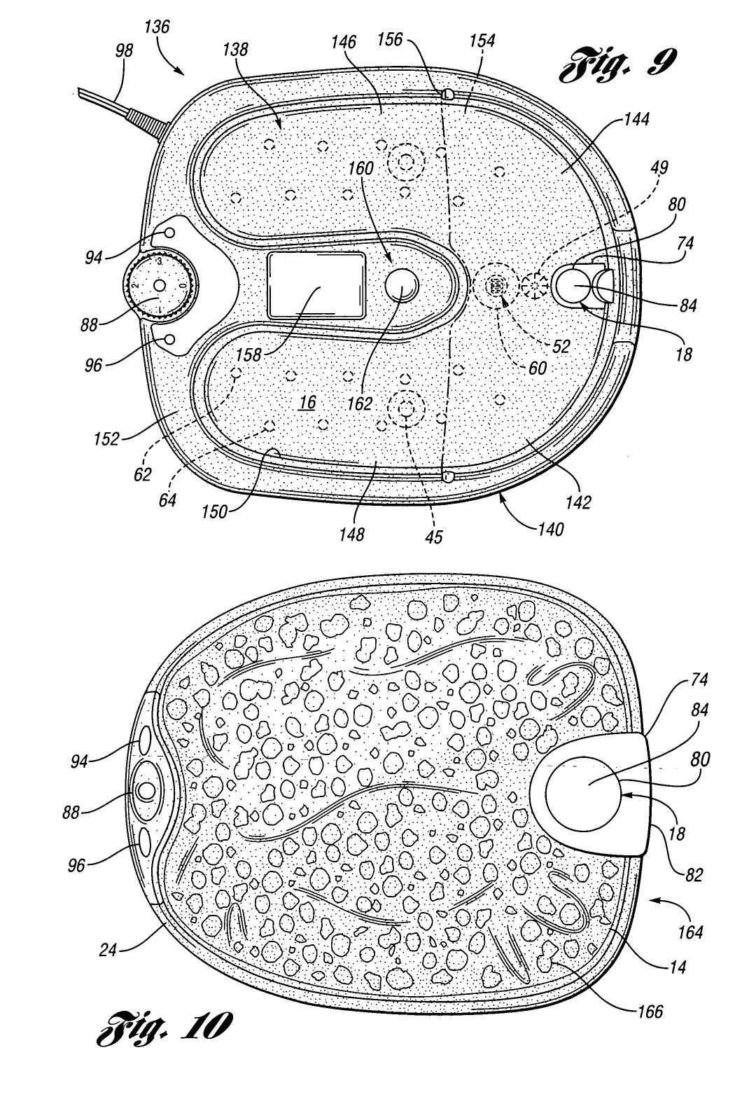

Referring now to FIG. 9, an alternative embodiment foot therapy apparatus 136 is provided in accordance with the teachings of the present invention. Like elements retain same reference numerals wherein new elements are provided with new reference numerals. The foot therapy apparatus 136 combines the teachings of the prior embodiment recessed within a bath chamber 138 provided within a foot bath housing 140. Bath apparatuses are well known in the art, such as assignee's U.S. Pat. No. 6,393,633 B2 invented by Roman Ferber and issued on May 28, 2002, which is incorporated in its entirety by reference herein.

The foot therapy apparatus 136 includes a U-shaped bladder 142 recessed within the bath chamber 138, which may be submerged in water or a similar fluid so that a body portion of the user, such as the feet, may experience a submerged water therapy that may be vibrated and/or heated and concurrently the therapy features provided in the prior embodiment. A bottom surface 144 of the bath chamber 138 acts as the substrate for supporting the bladder 142. The housing 140 defines a pair of sides 146, 148 to each receive respective feet of the user. Additionally, the housing 140 includes a wall structure 150 for retaining the bladder 142 and water therein and extending upwardly to an upper surface 152. The housing includes a lid 154 as illustrated in phantom, which is hinged relative to the housing 140 and provides additional support to the user's foot when rested thereon. Accordingly, a pair of openings 156 are provided for latching the lid 154 thereto.

The foot therapy apparatus 136 incorporates many of the operational features provided in the Ferber '633 patent. For example, egress ports (not shown) are provided within the wall structure 150 for providing a bubbling effect to the water within the bath chamber 138. Additionally, a heating member 158 is provided on a central portion 160 for providing targeted heat to the feet of the user. Additionally, a cap 162 is also provided on the central portion 160 for providing various other targeted therapy operations as disclosed in the Ferber '633 patent.

Referring to FIG. 10, another embodiment foot therapy apparatus 164 is illustrated. The foot therapy apparatus 164 is similar to the foot therapy apparatus 10 of FIGS. 1-8, however the present embodiment includes an aesthetic indicia 166 provided upon the foot rest surface 16 of the bladder 14. The indicia 166 provides a uniform aesthetic appearance and covers the operational components provided beneath, thereby resulting a streamlined appearance. The indicia 166 illustrated represents water droplets so that a consumer will experience an aesthetic perspective that is associated with water. Additionally, the indicia 166 will help consumers identify the features of the foot therapy apparatus 164. All though water droplets are illustrated, any indicia is contemplated within the spirit and scope of the invention. The indicia 166 may be partially opaque for permitting the aforementioned illumination effects to pass therethrough.

In summary, the present invention discloses a competitive and effective body therapy apparatus that provides a flexible fluid support to a portion of a body of a user such as feet, hands, head or the like, in combination with various other therapeutic features such as massage, heat, visual aesthetic display, or various features found in the art of bath apparatuses.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A foot massager comprising:
a portable substrate adapted to rest upon an underlying support surface;
a flexible bladder mounted upon the substrate, the bladder having a top surface spaced apart from the substrate that is sized to receive a pair of feet of a user thereupon, the bladder for retaining fluid therein, thereby providing a flexible fluid support to the feet of the user; and
a fluid pump in fluid communication with at least one aperture formed in the substrate for pumping the fluid within the bladder thereby imparting a fluid flow massage effect to the user's feet.

2. The foot massager of claim 1 further comprising a vibratory massage mechanism operably cooperating with the substrate for vibrating the fluid within the bladder thereby imparting a fluid vibratory massage effect to the user's feet.

3. The foot massager of claim 1 further comprising a side wall extending from the substrate, partially enclosing the bladder for providing lateral support thereto.

4. The foot massager of claim 1 wherein the bladder includes ornamental indicia provided thereon for enhancing an aesthetic appearance thereof.

5. The foot massager of claim 1 wherein the bladder further comprises a fluid port for permitting the user to add and remove fluid.

6. The foot massager of claim 1 wherein the fluid is further defined as water.

7. The foot massager of claim 1 wherein the bladder further comprises a plurality of tabs extending peripherally therefrom, each affixed to the substrate.

8. The foot massager of claim 1 wherein the at least one aperture is further defined as a pair of spaced apart jets oriented to direct the fluid flow to the bladder top surface for imparting a forced fluid massage effect to each of the user's feet.

9. The foot massager of claim 1 wherein the substrate and bladder are disposed within the basin of a footbath for submerging the bladder within water so that the user may soak its feet while receiving the fluid flow massage effect from the fluid within the bladder.

10. The foot massager of claim 1 further comprising a heater mounted to the substrate for heating the fluid within the bladder thereby imparting a therapeutic heated fluid effect to the user's feet.

11. The foot massager of claim 10 wherein the heater is further defined as a sheath heater for transferring heat across a surface area.

12. The foot massager of claim 10 further comprising a thermostat in communication with the heater for regulating a maximum temperature of the heater.

13. The foot massager of claim 10 further comprising a plurality of light emitting diodes (LED's) mounted to the substrate wherein the bladder is formed from an at least partially translucent material so that the LED's convey an illumination effect through the bladder, wherein the plurality of LED's further comprise a plurality of red LED's that illuminate upon the fluid reaching a predefined temperature.

14. The foot massager of claim 1 further comprising a plurality of light emitting diodes (LED's) mounted to the substrate wherein the bladder is formed from an at least partially translucent material so that the LED's convey an illumination effect through the bladder.

15. The foot massager of claim 14 further comprising a translucent plate oriented between the bladder and the substrate for distributing a load from the bladder to the substrate and permitting an the LED's to convey the illumination effect therethrough.

16. The foot massager of claim 14 wherein the plurality of LED's further comprise a plurality of blue LED's and a plurality of red LED's for conveying a plurality of illumination effects, each corresponding to an operating mode of the massager.

17. The foot massager of claim 16 further comprising an integrated circuit chip in operable communication with the LED's for providing an aesthetic illumination display.

18. The foot massager of claim 1 further comprising a housing having an internal cavity wherein the fluid pump is oriented within the housing internal cavity and the substrate is mounted to the housing adjacent to the internal cavity.

19. The foot massager of claim 18 further comprising elastomeric feet mounted to an underside of the housing for dampening vibrational impact to the underlying support surface resultant from the fluid pump.

20. The foot massager of claim 18 further comprising a switch mounted on the housing in operable communication with the fluid pump for controlling the operation of the massage mechanism, the switch being sized to be actuated by a user's foot.

21. The foot massager of claim 20 wherein the switch is further defined as a three position switch to provide a massage operation, a combined massage and heat operation, and an off position.

22. A foot therapy apparatus comprising:
a portable substrate adapted to rest upon an underlying support surface;
a flexible bladder mounted upon the substrate, the bladder having a top surface spaced apart from the substrate that is sized to receive a pair of feet of a user thereupon, the bladder for retaining fluid therein, thereby providing a flexible fluid support to the feet of the user; and
a heater mounted to the substrate for heating the fluid within the bladder thereby imparting a therapeutic heated fluid effect to the user's feet.

23. A foot therapy apparatus comprising:
a housing adapted to rest upon an underlying support surface, the housing having an internal cavity and an opening formed therein spaced apart and facing away from the underlying support surface;
a substrate mounted within the housing internal cavity adjacent to the opening;
a flexible bladder formed from a generally translucent material, mounted upon the substrate and at least partially received within the housing internal cavity for receiving lateral support therefrom, the bladder having a top surface spaced apart from the substrate that is sized to receive a pair of feet of a user thereupon, the bladder retaining fluid therein, thereby providing a flexible fluid support to the feet of the user; and
a plurality of light emitting diodes (LED's) mounted to the substrate for conveying an illumination effect through the bladder.

24. A portable massage apparatus comprising:
a housing;
a massage surface mounted to the housing for contacting a body part of a user;
a massage mechanism oriented within the housing for imparting a massage effect to the massage surface for massaging the body part; and
a light source mounted to the massage surface for conveying an illumination effect from the massage surface.

25. The massage apparatus of claim 24 wherein the light source further comprises at least one light emitting diode (LED).

26. The massage apparatus of claim 24 wherein the light source indicates a mode of massage operation of the massage mechanism.

27. The massage apparatus of claim 24 wherein the massage surface is generally translucent and the light source is oriented within the housing beneath the massage surface for conveying the illumination effect through the massage surface.

28. The massage apparatus of claim 24 further comprising a generally translucent housing intermediate portion provided adjacent to the massage surface, wherein the light source is oriented within the housing for conveying the illumination effect through the housing intermediate portion.

29. The massage apparatus of claim 24 wherein the housing is adapted to rest upon an underlying support surface and the massage surface is sized to receive a body part rested thereon.

30. The massage apparatus of claim 24 further comprising a heater oriented in the housing for heating the massage surface thereby imparting a therapeutic heated effect to the user's body part.

31. The massage apparatus of claim 30 wherein the light source further comprises at least one red light emitting diode (LED) to indicate a heating operation.

32. The massage apparatus of claim 24 wherein the light source further comprises a plurality of light emitting diodes (LED's) of a first color and a plurality of LED's of a second color for conveying a plurality of illumination effects, each corresponding to an operating mode of the massager.

33. The massage apparatus of claim 32 further comprising an integrated circuit chip in operable communication with the LED's for providing an aesthetic illumination display.
